(19) United States
(12) Patent Application Publication
(10) Pub. No.: US 2012/0017242 A1
(43) Pub. Date: Jan. 19, 2012

(54) Long Distance Audio Attendance

(75) Inventor: Nicholas B. Newell, Highlands Ranch, CO (US)

(73) Assignee: EchoStar Technologies L.L.C., Englewood, CO (US)

(21) Appl. No.: 12/837,759

(22) Filed: Jul. 16, 2010

(51) Int. Cl. H04N 5/445; H04N 7/173

(52) U.S. Cl. 725/38; 725/116

(57) ABSTRACT

In one embodiment, a system or method is provided for collecting audio, video and/or graphical inputs from one or more viewers of a program. The received input(s) may then be provided to an aggregator that combines the received inputs into one or more aggregated audio, video, data and/or combined signals. Such aggregated signals may be generated based on one or more predefined or dynamically defined criteria. The aggregated signal may be provided by a system or method to an external user or customer connected via one or more distribution systems to other viewers of the program such that the viewers may substantially/simultaneously receive the one or more audio, video and/or data inputs provided by other viewers during given presentation of the program.

### TECHNICAL FIELD

The technical field relates generally to providing audio networking in conjunction with a distribution system.

### BACKGROUND

Generally, audio and video programs are provided to listeners and viewers (collectively, “viewers) through a distribution system in one direction, with little or no feedback from the viewer. As a result, such programs are typically a passive interaction, wherein the viewer has no venue through which to respond to what the viewer is seeing and hearing. This inability to provide a reaction to the viewed program provides a degraded viewing experience, both for the viewer himself and, in some instances, the subject of the program. For example, a program may include a news conference with a celebrity or other person of interest. Typically, the viewer has little to no avenue to ask a question of the celebrity during the news conference (except through a third party system such as a telephone) and must instead rely on the persons in live attendance at the news conference to ask relevant questions pertaining to the viewer's interest. Thus, the viewer may not be able to glean the information he/she wants from the person of interest. In another example, a music performer giving a live studio performance is typically unable to hear the reaction to the performance from any of the viewers that may be listening to or watching the performance via one or more content distribution systems, such as cable, satellite, internet, wireless, or the like.

### BRIEF SUMMARY

A method and system is described for providing audio feedback associated with a program to the performer or subject of the program as the program is being presented in order to enhance the viewing experience. In addition, a method and system for providing audio reaction to other viewers of the program as the program is being presented may also be useful to enhance the viewing experience for the viewers.

In one embodiment, a method for providing long distance audio attendance corresponding to a program is described. The method may include the operations of receiving a plurality of multimedia inputs from one or more users, accessing one or more criteria defining at least one of the plurality of multimedia inputs, aggregating the plurality of multimedia inputs into an aggregated multimedia output signal based on the one or more criteria and transmitting the aggregated multimedia output signal over a network to one or more customers.

In another embodiment, a multimedia distribution system may include an aggregator configured to receive a plurality of multimedia inputs from a plurality of receivers over a network and aggregate the plurality of multimedia inputs into an aggregated output signal. The system may additionally and/or alternatively include a head-end configured to receive the aggregated output signal from the aggregator and transmit the aggregated output signal over the network simultaneously with the presentation of a program to which one or more of the multimedia inputs relates or refers.

In yet another embodiment, a method of receiving an aggregated multimedia signal from a network connection associated with a program is described. The method may include the operations of receiving one or more criteria from a user of a receiver, the one or more criteria identifying one or more multimedia inputs from viewers of a program and transmitting the one or more criteria over a first network to an aggregator configured to aggregate a plurality of multimedia inputs from the viewers of the program. The method may additionally and/or alternatively include the operations of receiving, via a second network, the plurality of multimedia inputs comprising the multimedia inputs defined by the one or more criteria and transmitting the plurality of multimedia inputs to a rendering device for presentation to the user substantially simultaneously during a presentation, for example but not limited to a broadcast, of the program.

### BRIEF DESCRIPTION OF THE DRAWINGS

FIG. 1 depicts an embodiment of a satellite distribution system utilizing an aggregator/server to provide audio from one or more viewers of a program to an external customer.

FIG. 2 is a flowchart depicting one embodiment of a method for receiving audio from one or more viewers of a program, aggregating the audio signals based on predefined parameters and providing the aggregated audio to an external customer of a satellite distribution system.

FIG. 3 depicts one embodiment of a satellite distribution system utilizing an aggregator/server to provide audio from one or more viewers of a program to other viewers of the program over a network.

FIG. 4 depicts an embodiment of a satellite distribution system utilizing an aggregator/server to provide audio from one or more viewers of a television program to other viewers of the program over a satellite-based communication service.

FIG. 5 depicts a second embodiment of a satellite distribution system utilizing an aggregator/server to provide audio from one or more viewers of a program to other viewers of the program.

### DETAILED DESCRIPTION

One implementation of the present disclosure may take the form of a system or method for collecting audio input from one or more viewers of a program during, or soon after, the presentation of the program on a distribution system or network such as, but not limited to, a satellite, cable or internet network. The audio input from the viewers may then be provided to a computing device, such as a server, that can filter the audio inputs based on predefined criteria and combine signals meeting the criteria. Once the input audio signals are combined, the embodiment may provide the aggregated signal to an external customer of the distribution system and/or other person(s). For example, the aggregated audio signal may be provided to a studio where a performer is performing a musical routine such that the performer may hear the aggregated audio from the one or more viewers. In another embodiment, the aggregated audio signal may be provided to other viewers of the programming through the distribution system, such that the viewers may hear one or more audio inputs provided by other viewers during broadcast of the programming (for example, speech of other users). Additionally, one or more embodiments may be combined such that the aggregated audio signal may be provided to both an external customer as well as to other viewers of the programming.

In the embodiment where the aggregated audio is provided to the external customer, the external customer may customize which audio inputs from viewers and/or other participants make up the aggregated audio signal by providing one or more parameters or criteria to the distribution system that identify the type of audio inputs requested. Alternatively, the distribution system may define the criteria by which the audio is aggregated prior to transmitting the aggregated audio to the external customer. In an embodiment in which the aggregated audio is provided to other viewers of the audiovisual program or other presentation, each viewer, or a group of any number of viewers, may provide parameters that define the requested aggregated audio signal that is heard by the one or more viewers during presentation (for example, during a broadcast) of the program. In addition, several security features may be included to identify which viewers may have access to the aggregated signal, such as lock-out procedures for misuse of the audio signals or a pay-per-view type agreement between the viewer and the distribution system that provides access to the aggregated audio signal.

In addition, aspects of the present disclosure may also apply to forms of multimedia signals other than audio. For example, the systems and methods described herein may also collect video inputs from one or more viewers of a program during, or soon after, the presentation of the program by utilizing a video camera or other video collecting device. The collected video inputs may then be filtered based on one or more criteria and aggregated into a video output displaying the various video inputs simultaneously in a grid, matrix, or other fashion. This video output may then be transmitted through a network to an external customer of the distribution system and/or other person(s). Similarly, graphical indicators (or avatars) of viewers of the distribution system or text data from the viewers may also be collected, filtered and transmitted as described herein. In general, although the present disclosure is presented in terms of an aggregated audio signal, the features discussed below may also apply to any multimedia signal, including audio, video or data, collected through a distribution system, combined into an aggregated signal and provided to one or more viewers of the distribution system or to an external customer to the system.

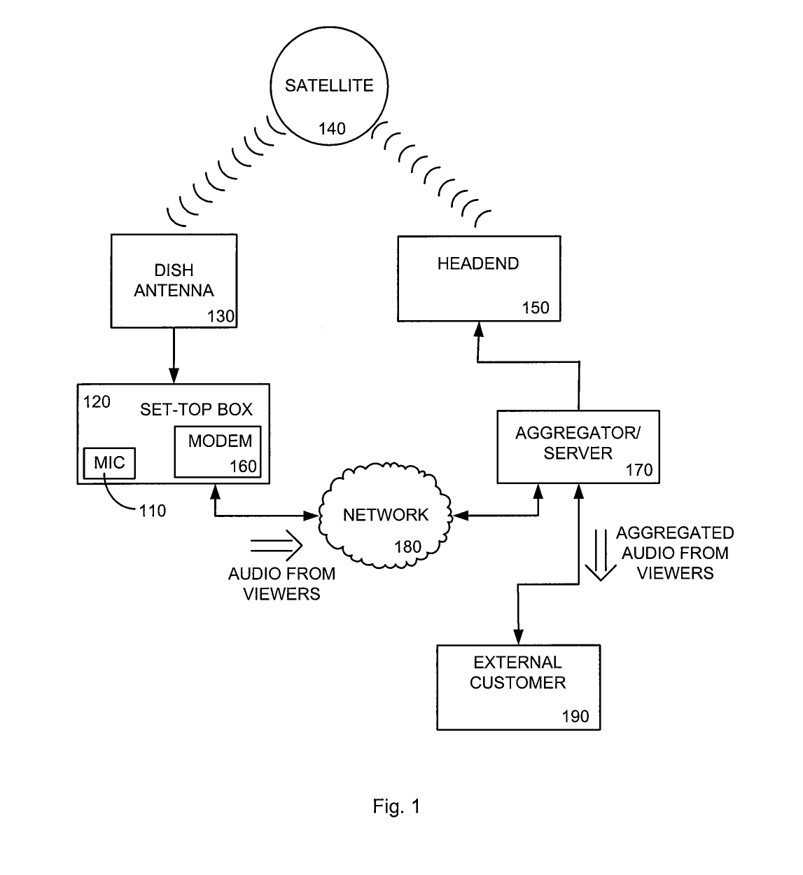

FIG. 1 depicts an implementation of a satellite distribution system utilizing an aggregator/server to provide audio inputs from one or more viewers of a program to an external customer. The satellite system of FIG. 1 is but one example of a system that may provide aggregated audio to an external customer. Alternatively, a digital cable system or any other system may also utilize the embodiments described herein. Further, it should be appreciated that the system may include more or fewer components than described herein and such components may be interconnected in any manner, additionally any type of signal may be communicated by the system, such as a video signal, an audio signal, an interactive signal, other signal types and any of various combinations and/or permutations of the foregoing. In general, any distribution system that provides multimedia presentations to a user for viewing may utilize the embodiments described herein.

The system of FIG. 1 may include at least one set-top box (STB) 120 configured to provide a user with an interface to the system. As described above, the STB 120 of the system may receive an encrypted signal and convert it into a signal that a display or other compatible device may recognize and manipulate in order to present the program to one or more users. Further, the STB 120 may provide the converted signal to a display device, such as a television or computer screen, for display to the user. In one implementation, the STB 120 may receive the encrypted signal from a satellite 140 or through a digital cable or network connection. Further, in the satellite and digital cable configurations, the encrypted signal may be generated by a headed 150 and transmitted to the STB 120. Generally, the head-end 150 may be a master facility that receives programming signals for processing and distribution to various systems. In a satellite television provider, the head-end 150 may transmit the audio/visual signal to a satellite 140 for redistribution to end users, for example, subscribers to a satellite or cable television distribution system. Upon receipt, the satellite 140 may transmit the signal to an dish antenna 130 connected to the STB 120 for decryption.

In a cable television system configuration, the head-end 150 may transmit the television signal directly to the STB 120 over a cable network connection. For example, the signal may be provided to the STB 120 through a cable connected, directly or indirectly, between the STB 120 and the head-end 150. Alternatively, the signal may be provided over a network 180 connection, utilizing for example a modem 160 associated with the STB 120.

Additionally, the head-end 150 may utilize the network 180 to provide other communication signals to the STB 120. For example, the head-end 150 may utilize the network 180, the satellite 140 or other telecommunications connections to provide programming updates to the STB 120. Similarly, the STB 120 may communicate information to the head-end 150 or to other networked devices, for example, an instruction and information used to store information at the head-end, within the network 180 or otherwise. In one implementation, the network 180 may be the internet such that the signals transmitted over the network may include an internet protocol (IP) address and may take the form of standardized packets of information for proper routing. In addition, the network may include and/or utilize various communication and networking topologies such as wireless, for example, WiFi, Bluetooth, WiMax, 3G, 4G and the like, and/or wired, such as POTS, LAN, WLAN, and the like, and/or any other known or hereinafter developed method to connect to the internet.

While the system shown in FIG. 1 includes a single STB 120, in general, a single head-end 150 and satellite device may provide the audio/visual signal to several STBs 120 simultaneously. In addition, several STBs 120 may be associated with a single aggregator 170 such that the aggregator may receive signals from a plurality of STBs rather than from a single STB as shown. Further, in some implementations the network 180 may include several aggregators 170 interconnected with several STBs 120 to create a network of aggregators communicating with several STBs associated with one or more users of the television system. In general, the distribution system may include any number of the components shown interconnected in any configuration to receive and create an aggregated audio signal over the distribution system.

Although the terms “STB” and “satellite system,” or variants thereof, are used throughout this document, it should be understood that other hardware and/or networks may be used for example, one embodiment may employ a cable box and a cable network. Accordingly, the term “STB” is intended to encompass other similar hardware, just as networks other than satellite systems are embraced by that term or the words “distribution network.”

As described in more detail below, the aggregator 170 may receive audio inputs from one or more STBs 120 across the network 180. These signals may be collected by the user's STB 120 by a microphone 110 associated with the STB. In one implementation, the microphone 110 may be embedded within the STB 120 and configured to collect sound from the area surrounding the STB 120. In another implementation, the microphone 110 may connect to an external I/O port of the STB 120, such as a USB connector. In yet another, the microphone may be part of or associated with a remote control or remote communications device. The STB 120, may transmit the collected audio input through the network 180 to the aggregator 170 for combination with other audio inputs.

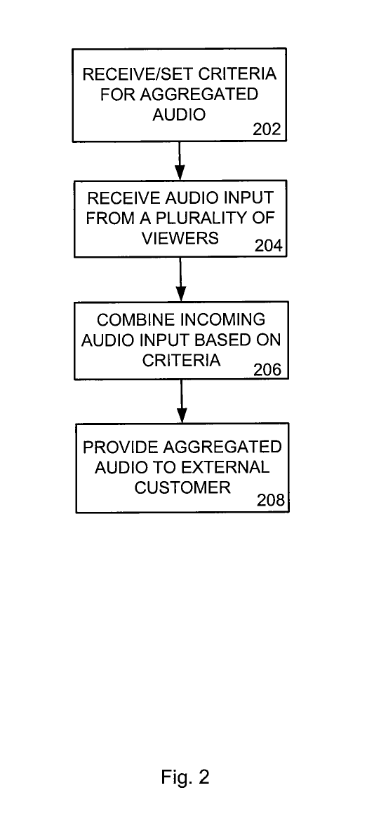

FIG. 2 is a flowchart depicting a method for utilizing the implementation shown in FIG. 1 to receive audio from one or more viewers of a program, aggregate the audio signals based on predefined parameters and provide the aggregated audio to another user. In general, the operations of FIG. 2 may be executed by the aggregator 170 of FIG. 1. However, in some embodiments one or more operations of the flowchart of FIG. 2 may be performed by other components of the distribution system, such as the head-end 150 or any number of components of the network 180. Further, although an example of a talk show television program will be used to describe the operations of the flowchart, it should be appreciated that the external customer 190 may be any entity that is configured to receive an aggregated audio signal from a distribution system or aggregator 170 via one or more network or other communication network topologies. For example, the external customer may include any type of television program, such as a musical performer giving a live concert, a stand-up comedian, a live sketch comedy program, a news conference including questions and answers of a person of interest, and so on.

Beginning in operation 202, the aggregator 170 may receive or establish one or more criteria to define which audio inputs are desired by the external customer 190. In one implementation, a talk show program provider, producer, or associated computing system may be provided a list of possible parameters that define one or more audio inputs from viewers of the program. The talk show provider, producer, or associated computing system (collectively, “talk show entity”) may then select from the provided list a set of criteria to define the types of viewer audio the talk show prefers to receive. For example, one subject that may be discussed on the talk show may pertain to a particular segment of the country, such as a news story affecting a certain city. To receive feedback from viewers of that city, the talk show entity may request viewer audio inputs from a zip code that defines the particular segment of the country. This selected criteria may be provided to the aggregator 170 or distribution system by the talk show entity prior to the presentation of the talk show program such that the requested aggregated audio may be provided to the talk show entity when the show airs. In another implementation, the system may receive the criteria during a presentation of the program and adjust the aggregation of the audio “on the fly” as different segments of the viewer audio input is requested.

In an alternate implementation, the distribution system may set the audio criteria based on the information received from the external customer 170. In this implementation, the external customer 170 may provide a description of the type of aggregated audio that the external customer desires. Using this information, an administrator of the distribution system may set the specific criteria of the aggregator 170 to match the audio inputs requested by the external customer 190. For example, the talk show entity may identify a particular viewer of the program as one to answer a question of the talk show guest. The viewer's name may be provided to the administrator, who in turn may determine an ID number for that particular viewer. In another embodiment, the aggregator 170 may set one or more criteria dynamically for a viewer based on the viewer's viewing history or determined interests. Once the viewer's audio input is identified, the administrator may set a criteria with the aggregator 170 to allow that person's audio input to be transmitted to the talk show entity or studio.

Generally, the criteria used to select the viewer audio inputs that are included in the aggregated audio signal may include any parameter that identifies or classifies an incoming audio signal. For example, audio received from a plurality of STBs 120 may also include information such as the user's STB ID, smartcard ID, zip code, an authorization number, username, internet protocol (IP) address, MAC address or any other identification associated with the user or the user's equipment. In addition, the criteria may include preferences of the user, such as the user's favorite sports team, favorite band, friends list, favorite channels, favorite celebrities and so on. Preferences may even be automatically assembled based on the viewer's viewing history. In such an implementation, the STB 120 may monitor and analyze the user's viewing history and use such information to create a profile of the viewer's taste, which further may be sent along with or separately from the viewer's audio input to the aggregator 170. This information may be transmitted from the user's STB 120 to the aggregator 170 and utilized to filter and combine a plurality of viewer audio inputs into an aggregated audio signal, as requested or defined by the external customer 190.

In operation 204, the aggregator 170 may receive audio inputs from one or more viewers of a television program. In some embodiments, the number of viewers that are allowed to provide audio inputs may be limited. For example, prior to or during the airing of the talk show program discussed above, a viewer may utilize an interface of the STB 120 to notify the entity/system that the viewer would like to be an audio attendee of the talk show. For some programs, audio attendance to the particular program may require an additional payment or fee, while other programs may be open to any willing attendee. The audio attendance request may then be sent over the network 180 to one or more servers/aggregators 170 to create a communication channel between the aggregator and the user's STB 120. In addition, one or more segments of identifying information (as discussed above) may also be transmitted to the aggregator 170 for use in filtering the audio inputs. As should be appreciated, the number of audio attendees may vary from a few viewers to several million, depending on the popularity of the program and the availability of the audio attendance feature.

During broadcast of the talk show, the microphone 110 associated with the STBs 120 of each user identified as a valid audio attendee may be activated to collect the audio input provided by the viewers. In this manner, the aggregator 170 may receive audio inputs from one or more viewers of a program as the program airs.

In operation 206, the aggregator 170 may identify one or more audio inputs based on the established criteria defined in operation 202 and combine the identified audio inputs into an aggregated audio signal. For example, the criteria defined in operation 202 may identify each audio input received from Denver, Colo. or may identify each audio input from a viewer who has identified the talk show's guest as a favorite celebrity. In general, the aggregator 170 may use the information provided with each viewer audio input to filter out or select particular inputs for combining.

In operation 208, the aggregated audio signal may be provided to the external customer 190. The transmission of the aggregated signal may occur over any type of network, such as a satellite network, a digital cable network, the internet and so on. Further, the aggregator 170 may vary the sound level of the provided aggregated signal to account for the multiple audio inputs. For example, an aggregated signal that combines several hundred audio signals may equalize the sound volume for each audio input so that the aggregated signal is not unnecessarily variant. Alternatively, if the aggregated signal includes a single quiet audio input, such a signal may be boosted to raise the sound level such that the external customer 190 may hear the audio input. Once the aggregated audio signal is provided to the external customer 190, the customer may configure the audio as desired, such as providing it to a studio from which a television program is airing.

In one implementation, the aggregated audio signal may be transmitted by the distribution system to one or more external customers 190. This signal may be encrypted and transmitted over a secure communication line to the external customer 190. In another implementation, the aggregator 170 may offer the aggregated signal to any external customer 190 willing to access the aggregator and retrieve the aggregated signal.

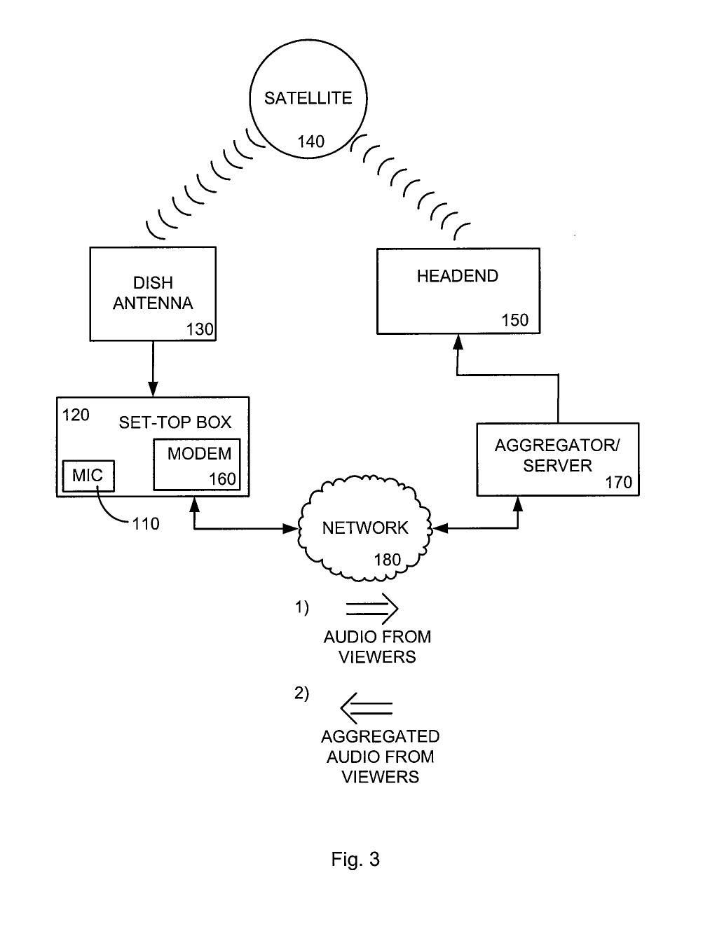

FIG. 3 depicts one embodiment of a distribution system utilizing an aggregator/server 170 to provide audio inputs from one or more viewers of a program to other viewers of the program over a network. In general, the components of the system depicted in FIG. 3 are similar to the components described above with reference to FIG. 1 and may be configured to operate in a similar manner.

The operation of the implementation depicted in FIG. 3 is described below with reference back to FIG. 2. In general, the operation of this implementation is similar to that described above. However, in this implementation, the aggregated audio signal may be provided to one or more viewers of the program rather than an external customer.

Beginning in operation 202, the aggregator 170 may receive or establish a set of criteria to define which audio inputs are desired by one or more users of a program. In one implementation, the criteria may be selected by the users when the user requests to be an audio attendee. For example, as described above, a user wishing to receive an aggregated audio signal for a particular program may request such access prior to or during the airing of a program by accessing an interface associated with the user's STB 120. In addition to providing access as an audio attendee, the interface may also request filtering criteria from the user such that the user can tailor the aggregated audio signal received by the user's STB 120. For example, a user may select to receive only audio inputs from viewers who are fans of a particular football team while watching a football game. In one implementation, the interface may provide the user with a list of possible filtering criteria from which the user can select. In another implementation, the interface may provide the user with the option of providing one or more identifying criteria, such as a username or STB ID that identifies one or more other viewers from which the user would like to receive an audio input. In this manner, the user may select audio inputs from a group of other viewers or by individually identifying particular viewers.

Further, the criteria selected by the user may include one or more filtering parameters. For example, in addition to selecting to hear audio inputs from fans of a particular football team, the user may also select to further limit the audio inputs by area, such that the user receives an aggregated audio signal of fans of a particular football team viewing the football game in a particular area, such as the viewer's home town. In general, any number of criteria may be selected and applied to tailor the aggregated audio signal received by a user.

In one implementation, the criteria selected by the user may be stored in a computer-readable medium associated with the user's STB 120. During broadcast of the program corresponding to the requested aggregated audio signal, the criteria may be routinely provided to the aggregator 170 such that the user receives the requested aggregated signal. Further, such criteria may be adjusted by the user during broadcast to request a different aggregated audio signal. In another implementation, the user's criteria selections may be transmitted to the aggregator 170 upon selection and stored therein such that the aggregator can filter the viewer audio inputs to create the requested aggregated audio signal.

In operation 204, the aggregator 170 may receive audio inputs from one or more viewers of a program. The audio signal may be collected from the viewers through microphone 110 associated with the viewer's STB 120, as described above.

In operation 206, the aggregator 170 may identify one or more audio inputs based on the established criteria defined in operation 202 and combine the identified audio inputs into an aggregated audio signal. For example, in operation 202, one or more viewers may provide a group of usernames (or other identifying information) to the aggregator 170. Continuing this example, usernames may define a group of viewers that wish to discuss a particular program together utilizing an aggregated audio signal as the program airs over the distribution system. Each viewer that is part of the discussion group may provide the username of each of the other group members to create the discussion group. The aggregator 170 may then utilize the provided usernames to select the proper viewer audio inputs from the identified viewers and create an aggregated audio signal that is transmitted to the identified viewers during the airing of the program. In this manner, the aggregator 170 may create a unique aggregated signal for each viewer of the program that includes the audio inputs from each of the other viewers identified by the discussion group.

In other implementations, the aggregator 170 may create an aggregated signal that is transmitted to several viewers, rather than providing each viewer with a customized aggregated signal. For example, one of the viewers of the program may be a director of the particular program that is associated with the aggregated audio signal. The director may provide a live, running commentary of the program as the program airs. Using the embodiments described herein, viewers of the program may request to hear the director commentary by requesting access to the commentary (as described above with reference to operation 202) and selecting to hear the director's commentary from a list of filtering criteria. Thus, in this implementation, a single audio input provided from the director may be transmitted to several viewers of the program. In general, the aggregated audio signal may be customized for each individual viewer or a single audio signal may be provided to several viewers simultaneously. The determination of the aggregated signal received by each registered viewer is associated with the criteria provided by each viewer in operation 202.

Additionally, the aggregator 170 may apply one or more security features to prevent misuse of the aggregated audio distribution system. For example, the aggregator 170 may maintain a list of viewers banned from providing audio input based on previous misuse by one or more viewers. This list may identify a banned viewer with any type of identification, such as those described above. During broadcast of a program or other presentation or event, the aggregator 170 may identify and block any audio inputs coming from the banned viewers from being transmitted from the aggregator in the aggregated audio signal. In another implementation, the aggregator 170 may utilize voice recognition technology to identify potential violators of the standards of the audio system and automatically block the audio inputs provided by the identified viewers. In general, the aggregator 170 may maintain any level of decency desired by the administrators of the distribution system. For example, the aggregator 170 may be configured to analyze the audio inputs provided by the viewers to detect the use of inappropriate language. When a banned word is recognized by the aggregator 170, the aggregator may then block or disconnect the offending viewer from providing any other audio input for that program. Further, repeated violation of this policy may permanently ban a viewer from ever providing audio inputs to the aggregator 170.

In operation 208, the one or more aggregated audio signals may be provided to one or more users of the distribution system. In the implementation shown in FIG. 3, the aggregated audio signal may be transmitted to the users STB 120 through the same network 180 that the user's audio input is provided to the aggregator 170. In other words, the aggregated audio may be provided over a land-based communication line, such as the internet in one particular example, and received at the modem 160 of the STB 120. In other embodiments a different network may be used. Further, although only a single aggregated signal is shown, it should be appreciated that any number of aggregated signals may be provided by the aggregator 170 over the network 180 to any number of user STBs 120. In addition, it should be appreciated that the aggregated audio signal may include a single audio input, such as in the example where the user requests to hear the audio input from one other viewer. In general, the aggregated audio signal may include any number of audio inputs from viewers of the program.

Once received at the STB 120, the aggregated audio signal may be processed in a number of ways. For example, in one implementation, the STB 120 may combine the aggregated audio signal with the audio signal that accompanies the program. Thus, the user or viewer would hear a combination of the program audio and the aggregated audio signal emanating together from the user's speakers. In such an implementation, the STB 120 may adjust the sound-level for the incoming aggregated signal such that the aggregated signal compliments the program audio in a way that both the program audio and the aggregated signal can be heard by the viewer simultaneously. In another implementation, the sound-level of the aggregated audio may be adjusted by the user through an interface to the user's STB 120. In yet another, the aggregated audio may be provided as alternative audio to main audio, such as the audio associated with the program/event/presentation.

In yet another implementation, the STB 120 may provide the aggregated audio signal to the viewer on a separate audio channel associated with the program, similar to an alternate spanish-language audio channel that is often associated with current programs. In such an implementation, the viewer may access the aggregated audio signal by utilizing a remote control device associated with the user's STB 120 to select the alternate audio channel containing the aggregated audio signal. The separate audio channel may be configured to only provide the aggregated audio signal, or may be configured to include a combination of the program audio and the aggregated audio signal. In still yet another implementation, the aggregated signal may be converted into closed-captioned information and displayed on the viewer's display during broadcast of the associated program.

As described above, the aggregated signal may comprise video and/or data signals aggregated in a similar manner as described above for audio signals. In addition, access to these aggregated signals may be achieved in a similar manner as described, such as through the use of a remote control device to select the desired aggregated multimedia signal. For example, the viewer may use a remote control or other input device to provide a selection to the viewer's set-top box to select from an aggregated audio signal, an aggregated video signal and/or an aggregated data signal. In one implementation, more than one aggregated signal may be presented to the user at one time. For example, during presentation of the program, the aggregated audio may also be presented to the viewer along with an interface showing one or more avatars that represents the identity of each person included in the aggregated audio signal. In a similar manner, one or more video signals may be provided and accessed by the viewer that correlate to the program being presented. In this manner, the embodiments described herein may similarly apply to any multimedia signal, including a plurality of multimedia signals aggregated and presented to a viewer.

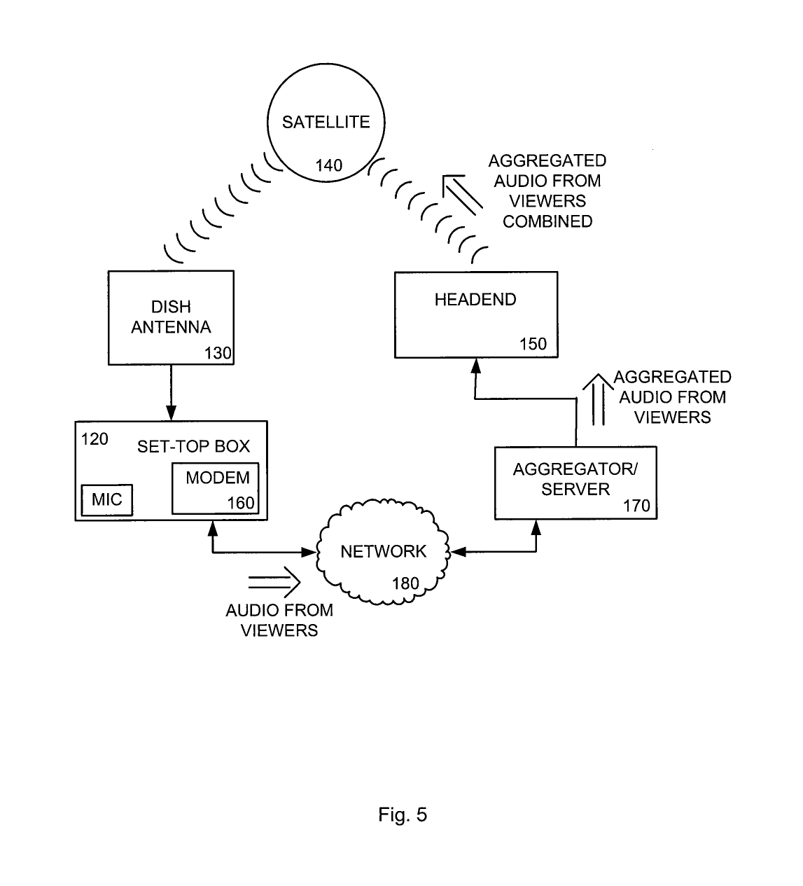

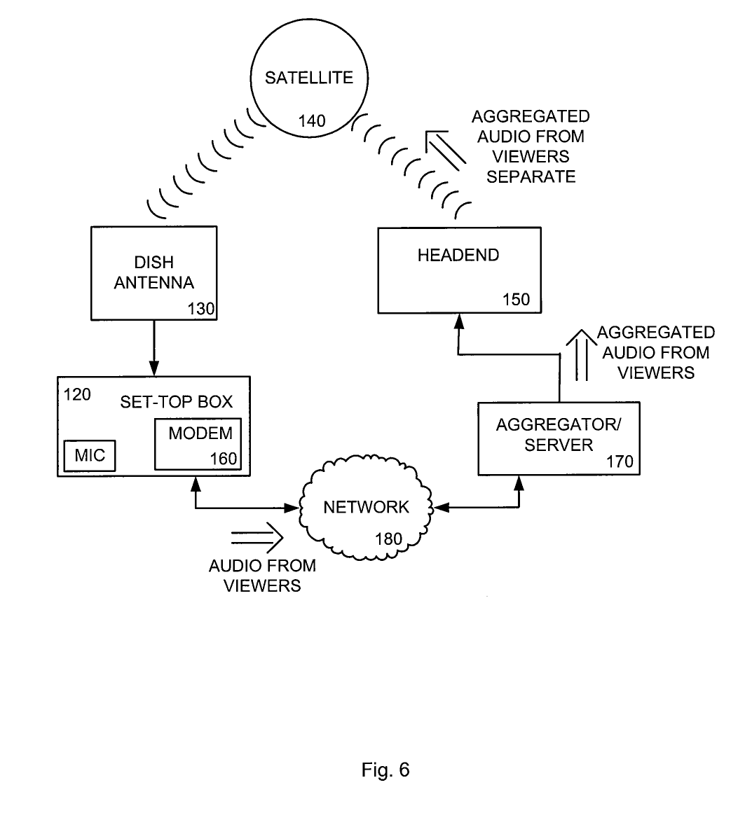

While the implementation shown in FIG. 3 illustrates providing the aggregated audio signal to a viewer through a land-based communication channel, the audio signal may also be provided to the viewer over a satellite-based communication network. FIG. 5 depicts a first embodiment of a satellite distribution system utilizing an aggregator/server 170 to provide audio inputs from one or more viewers of a program to other viewers of the program over a satellite-based communication service.

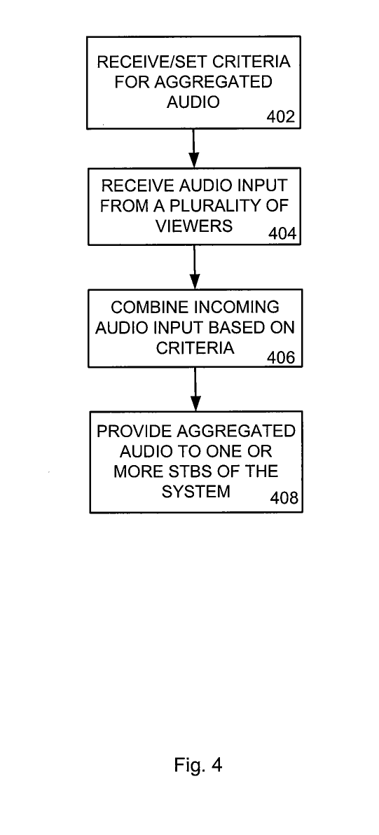

In general, the components of the distribution system shown in FIG. 4 are similar to those discussed above with reference to FIGS. 1 and 3. Further, the operations of those components operates similarly as described above. However, in this implementation, the aggregated audio signal may be provided to the head-end 150 of the satellite distribution system before being transmitted to the user's STB 120. As mentioned above, the head-end 150 may transmit an audio/visual signal to a satellite 140 for redistribution to subscribers of the system. This audio/visual signal may include the program to which the aggregated audio signal corresponds.

In the implementation shown in FIG. 4, the aggregated audio signal may be combined with the video signal that is sent to the satellite 140 and retransmitted to the user's STB 120. In the implementation where the aggregated audio is combined with the video signal prior to transmission to the satellite 140, the aggregated audio signal may be available to a viewer who wishes to listen to the audio while viewing the program. In this implementation, the aggregated audio signal may be combined with the audio for the program. Access to the aggregated signal may be achieved in any manner as described above.

Alternatively, the aggregated audio may also be transmitted separately from the video stream that includes the program associated with the aggregated audio. For example, FIG. 5 depicts a second embodiment of a satellite distribution system utilizing an aggregator/server 170 to provide audio from one or more viewers of a program to other viewers of the program over a satellite-based communication system.

In the implementation of FIG. 5, the aggregated audio signal may be transmitted separately from the video signal that includes the program associated with the aggregated audio. As should be appreciated, a single satellite 140 may provide a video signal to many STBs 120 such that each STB receives identical multimedia information. However, each STB 120 receiving the video signal may require one or more authorizations to access different programs within the video signal. For example, the satellite 140 may provide a video signal that includes several pay-per-view events. However, only those viewers that have paid for access to the pay-per-view events and have received and stored the appropriate access authorizations are able to view such events.

In a similar manner, the separate aggregated audio signal may be transmitted along with the video signal sent from the satellite 140 to the user's STBs 120. However, only those STBs 120 that have the proper authorization may decode and hear the aggregated audio signal. This implementation may be useful in situations where access to the aggregated signal is limited to those viewers that have paid an additional fee to hear the aggregated signal. Presentation of the aggregated audio signal may take any of the forms described above, however. For example, once the aggregated audio signal is properly accessed by the STB 120, the signal may be combined with the audio of the program such that the viewer hears both audio signals simultaneously. Alternatively, the aggregated signal may be presented on a separate audio channel or as closed-captioning, as described above.

It should be noted that the flowchart of FIG. 2 is illustrative only. Alternative embodiments of the present invention may add operations, omit operations, or change the order of operations without affecting the spirit or scope of the present invention.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

What is claimed is:

1. A method comprising:
receiving a plurality of multimedia inputs from one or more users;
accessing one or more criteria defining at least one of the plurality of multimedia inputs;
aggregating the plurality of multimedia inputs into an aggregated multimedia output signal based on the one or more criteria; and
transmitting the aggregated multimedia output signal over a network to one or more customers.

2. The method of claim 1 wherein the aggregated multimedia output signal comprises at least one aggregated audio signal and one aggregated video signal.

3. The method of claim 1 further comprising:
combining the aggregated multimedia output signal with an audio track associated with the program.

4. The method of claim 1 wherein the aggregated multimedia output signal is transmitted to an external customer upon a request from the external customer.

5. The method of claim 1 wherein the aggregated multimedia output signal is transmitted to an internal user of a distribution system.

6. The method of claim 4 wherein the one or more criteria are received from the external customer.

7. The method of claim 5 wherein the one or more criteria are received from the internal user.

8. The method of claim 1 wherein the network is a land-based communication network and the aggregated multimedia output signal is communicated using a second network topology that differs from a topology utilized with the network.

9. The method of claim 1 wherein the criteria includes at least one identifying parameter for at least one of the plurality of multimedia inputs.

10. The method of claim 1 wherein the criteria includes at least one preference for at least one of the one or more users of the distribution system.

11. A system comprising:
an aggregator configured to receive a plurality of multimedia inputs from a plurality of receivers over a network and aggregate the plurality of multimedia inputs into an aggregated output signal; and
a head-end configured to receive the aggregated output signal from the aggregator and transmit the aggregated output signal over the network substantially simultaneously with a multimedia program.

12. The system of claim 11 wherein the aggregated output signal comprises at least one aggregated audio signal and one aggregated video signal.

13. The system of claim 11 wherein the head-end is further configured to combine the aggregated output signal with the multimedia program.

14. The system of claim 11 wherein the head-end is further configured to transmit the aggregated output signal separately from the multimedia program.

15. The system of claim 11 wherein the aggregator is further configured to receive one or more criteria identifying at least one of the plurality of multimedia inputs.

16. The system of claim 15 wherein the aggregator is further configured to non-transiently store the one or more criteria in a computer-readable medium and aggregate the plurality of multimedia inputs based on the one or more criteria.

17. A method comprising:
receiving one or more criteria from a user of a receiver, the one or more criteria identifying one or more multimedia inputs from viewers of a program;
transmitting the one or more criteria over a first network to an aggregator configured to aggregate a plurality of multimedia inputs from the viewers of the program;
receiving, via a second network, the plurality of multimedia inputs comprising the multimedia inputs defined by the one or more criteria; and
transmitting the plurality of multimedia inputs to a rendering device for presentation to the user substantially simultaneously during a given presentation of the program.

18. The method of claim 17 wherein the one or more criteria are received from a user of the rendering device.

19. The method of claim 18 further comprising:
combining the aggregated audio signal with one or more graphical representations of audio participants receiving the presentation of the program.

20. The method of claim 18 further comprising:
presenting an interface to the user on the rendering device to receive the one or more criteria.
